(19) United States
(12) Patent Application Publication
(10) Pub. No.: US 2008/0073624 A1
(43) Pub. Date: Mar. 27, 2008

(54) Light-diffusing resin composition with advanced mechanical properties

(75) Inventors: Jeong Su Choi, Daejeon (KR); Deok Young Choi, Daejeon (KR); Seung Hyun Kim, Iksan (KR); Keun Hoon Yoo, Seoul (KR); Hyong Min Bahn, Yeosu (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: LG Chem, Ltd., Seoul (KR)

(21) Appl. No.: 11/824,078

(22) Filed: Jun. 28, 2007

(30) Foreign Application Priority Data
Sep. 21, 2006 (KR) 10-2006-0091830

(51) Int. Cl. C08J 3/12; C08F 8/30

(52) U.S. Cl. 252/582

(57) ABSTRACT

A light-diffusing resin composition is provided. The light-diffusing resin composition comprises a matrix resin containing a conjugated diene rubber resin. The matrix resin may be prepared by graft polymerization of a monomer mixture or a copolymer of an alkyl methacrylate or an alkyl acrylate, an aromatic vinyl compound and a vinylcyan compound onto a conjugated diene rubber resin. The light-diffusing resin composition has advanced mechanical properties, such as high impact resistance and improved processibility.

### BACKGROUND OF THE INVENTION

1. Field of the Invention

The present invention relates to a light-diffusing resin composition with excellent light diffusion properties, high impact strength and improved processibility. More specifically, the present invention relates to a light-diffusing resin composition that has good performance to transmit and diffuse direct rays of the sun or light from a fluorescent lamp or a light-emitting diode (LED) lamp, high impact resistance and improved processibility.

2. Description of the Related Art

In general, resin compositions with light diffusion properties are widely used as materials for illumination covers, illumination signboards, light-emission type switch signboards, etc. Light-diffusing resin compositions have attracted more and more attention in recent years due to the advanced technologies in display industry and rapid changes in illumination industry. Particularly, in the case of light-diffusing resin compositions used in LED illumination, the light diffusion properties of the light-diffusing resin compositions must be increased as much as possible to overcome the problem of bad light distribution and the transmittance of the light-diffusing resin compositions must be as high as possible to prevent loss of light. Further, in the case of light-diffusing resin compositions used in illumination signboards and outdoor billboards, the impact strength of the light-diffusing resin compositions must be high to some extent and the processibility of the light-diffusing resin compositions must be improved such that bulky materials can be extruded and injection-molded.

In view of these properties, light-diffusing resin compositions are generally prepared by adding a light-diffusing agent to a base resin (i.e. a matrix resin) to ensure light diffusion properties and transmittance. Examples of such matrix resins include transparent thermoplastic resins, such as methacrylic resins, styrene resins and polycarbonate resins.

However, these transparent thermoplastic resins are limited in their use because of their intrinsic characteristics. Specifically, methacrylic resins and styrene resins are very brittle due to their low impact strength. To overcome such disadvantages, various proposals have hitherto been made. For example, Korean Patent Application No. 10-2002-86995 discloses a light-diffusing resin composition comprising a methacrylic resin and an acrylic impact modifier. However, this resin composition shows only a very limited improvement in impact strength (≦3).

On the other hand, the use of polycarbonate resins results in an increase in impact strength but causes poor processibility, which makes it impossible to process into complicated structures.

Further, Korean Patent No. 0511487 describes a light-diffusing laminate resin sheet consisting of two layers wherein one layer is formed of a methyl methacrylate or styrene resin containing a rubbery polymer and the other layer is formed of a methyl methacrylate or styrene resin. However, the multilayer resin sheet has the disadvantage that the production process requires increased number of steps.

Thus, there is a need to develop a light-diffusing resin with advanced mechanical properties, such as improved processibility and high impact strength.

### SUMMARY OF THE INVENTION

It is an object of the present invention to provide a light-diffusing resin composition with advanced mechanical properties, such as improved processibility and high impact strength.

In accordance with an aspect of the present invention for achieving the above object, there is provided a light-diffusing resin composition which comprises a matrix resin containing a conjugated diene rubber resin, which makes the preparation of the resin composition simple.

Specifically, the light-diffusing resin composition of the present invention comprises 100 parts by weight of a transparent thermoplastic resin (A) containing a conjugated diene rubber resin and 0.1 to 20 parts by weight of a light-diffusing agent (B).

The transparent thermoplastic resin (A) is prepared by graft polymerization of a monomer mixture of 20 to 70 parts by weight of an alkyl methacrylate or an alkyl acrylate and 8 to 50 parts by weight of an aromatic vinyl compound onto 5 to 30 parts by weight of a conjugated diene rubber resin.

The monomer mixture, which is graft-polymerized onto the conjugated diene rubber resin to prepare the transparent thermoplastic resin (A), may further include 1 to 20 parts by weight of a vinylcyan compound.

On the other hand, the transparent thermoplastic resin (A) used in the light-diffusing resin composition of the present invention may be prepared by graft polymerization of a copolymer of an alkyl methacrylate or an alkyl acrylate and an aromatic vinyl compound onto a conjugated diene rubber resin. The copolymer, which is graft-polymerized onto the conjugated diene rubber resin to prepare the transparent thermoplastic resin (A), may be composed of an alkyl methacrylate or an alkyl acrylate, an aromatic vinyl compound and a vinylcyan compound.

The difference in refractive index between the conjugated diene rubber resin and the graft polymer, which consists of an alkyl methacrylate or an alkyl acrylate, an aromatic vinyl compound and a vinylcyan compound, is preferably 0.005 or less.

The conjugated diene rubber resin preferably has an average particle diameter of 600 Å to 5,000 Å.

The light-diffusing agent (B) preferably has a spherical shape with an average particle diameter of 0.1 to 100 μm.

The light-diffusing agent (B) may be selected from the group consisting of calcium carbonate, barium sulfate, titanium dioxide, aluminum hydroxide, silica, glass, talc, mica, white carbon, magnesium oxide, zinc oxide, and mixtures thereof.

The difference in refractive index between the transparent thermoplastic resin (A) and the light-diffusing agent (B) is preferably 0.005 or greater.

The transparent thermoplastic resin (A) may be prepared by copolymerizing 20 to 70 parts by weight of an alkyl methacrylate or an alkyl acrylate with 8 to 50 parts by weight of an aromatic vinyl compound (a first step) and graft-polymerizing the copolymer with 5 to 30 parts by weight of a conjugated diene rubber (a second step).

In the first step, 1 to 20 parts by weight of a vinylcyan compound may be further added during the copolymerization.

### DETAILED DESCRIPTION OF THE PREFERRED EMBODIMENTS

The present invention will now be described in detail.

The present invention provides a light-diffusing resin composition which comprises 100 parts by weight of a transparent thermoplastic resin (A), as a matrix resin, containing a conjugated diene rubber resin and 0.1 to 20 parts by weight of a light-diffusing agent (B) as a domain.

Explanations of the transparent thermoplastic resin (A) and the light-diffusing agent (B) will be provided below.

(A) Transparent Thermoplastic Resin

The light-diffusing resin composition of the present invention comprises a transparent thermoplastic resin (A), as a matrix resin, containing a conjugated diene rubber resin.

The conjugated diene rubber resin is a polymer of a conjugated compound having a structure in which single and double bonds alternate.

As the conjugated diene rubber resin, there may be used a butadiene polymer, a butadiene-styrene copolymer (SBR), a butadiene-acrylonitrile copolymer (NBR), an ethylene-propylene copolymer (EPDM) or a polymer derived therefrom. A butadiene polymer or a butadiene-styrene copolymer is particularly preferred.

The transparent thermoplastic resin (A) is prepared by graft polymerizing the conjugated diene rubber resin as a backbone chain with a monomer mixture of an alkyl methacrylate or an alkyl acrylate, an aromatic vinyl compound and a vinylcyan compound.

Alternatively, the transparent thermoplastic resin (A) may be prepared by previously copolymerizing an alkyl methacrylate or an alkyl acrylate, an aromatic vinyl compound and a vinylcyan compound as monomeric compounds, and graft polymerizing the copolymer onto the conjugated diene rubber resin.

The conjugated diene rubber resin used to prepare the transparent thermoplastic resin (A) preferably has an average particle diameter in the range of 600 Å to 5,000 Å. If the average particle diameter of the conjugated diene rubber resin is out of this range, undesirable results are obtained in terms of impact resistance and processibility. Therefore, the conjugated diene rubber resin having a particle diameter within the preferable range defined above is used to prepare the light-diffusing resin composition of the present invention.

The matrix resin used in the light-diffusing resin composition of the present invention may be a copolymer of 5 to 30 parts by weight (on a solids content basis) of the conjugated diene rubber resin, 20 to 70 parts by weight of an alkyl methacrylate or an alkyl acrylate and 8 to 50 parts by weight of an aromatic vinyl compound. The copolymer may further include 1 to 20 parts by weight of a vinylcyan compound.

Particularly, the copolymer is prepared by graft polymerizing the conjugated diene rubber resin as a backbone chain with the other compounds, i.e. an alkyl methacrylate or an alkyl acrylate, an aromatic vinyl compound and a vinylcyan compound. The compounds graft-polymerized onto the conjugated diene rubber resin may be directly grafted as monomers onto the conjugated diene rubber resin. The monomers may be previously polymerized and graft-polymerized onto the backbone chain.

Since the conjugated diene rubber resin used to prepare the matrix resin is provided in the form of a polymer latex solution containing insoluble ingredients, its content is represented as the solids content of the insoluble ingredients (i.e. gel content) in the polymer latex solution.

When the conjugated diene rubber resin is present in an amount of less than 5 parts by weight, the light-diffusing composition tends to be brittle due to its poor impact resistance. Meanwhile, when the conjugated diene rubber resin is present in an amount exceeding 30 parts by weight, a finished product manufactured using the light-diffusing composition is very soft and is thus likely to be damaged.

When the amounts of the alkyl methacrylate or alkyl acrylate and the aromatic vinyl compound used are out of the respective ranges (i.e. 20 to 70 parts by weight and 8 to 50 parts by weight) defined above, there is a large difference in refractive index between a graft polymer prepared from the monomer mixture and the conjugated diene rubber resin, thus adversely affecting the transparency of the transparent thermoplastic resin.

The transparent thermoplastic resin may optionally include 1 to 20 parts by weight of a vinylcyan compound. When the vinylcyan compound is used in an amount of less than 1 part by weight, there is little improvement in the impact resistance of the light-diffusing resin composition. Meanwhile, when the vinylcyan compound is used in an amount exceeding 20 parts by weight, the color of the light-diffusing resin composition turns yellow, which adversely affects the color of a finished product manufactured using the light-diffusing resin composition.

The matrix resin used in the light-diffusing resin composition of the present invention is prepared by graft polymerizing the conjugated diene rubber resin as a backbone chain with a monomer mixture composed of an alkyl methacrylate or an alkyl acrylate, an aromatic vinyl compound and optionally a vinylcyan compound. Alternatively, the matrix resin may be prepared by previously copolymerizing the monomer mixture and graft polymerizing the copolymer onto the conjugated diene rubber resin.

The refractive index of the monomer mixture or a copolymer thereof, which is graft-polymerized onto the conjugated diene rubber resin as a backbone chain, absolutely affects the transparency of the transparent thermoplastic resin (A). That is, the transparency of the transparent thermoplastic resin (A) is determined depending on the kind and amount of the components used for the graft polymerization compounds.

In order that the transparent thermoplastic resin (A) may be transparent, the difference in refractive index between the conjugated diene rubber resin as a backbone chain of the graft polymer and the graft polymer thereof must be smaller than 0.005, and is preferably zero.

If the difference in refractive index is greater than 0.005, the transparent thermoplastic resin (A) is no longer transparent, which is undesirable.

Representative components of the transparent thermoplastic resin (A) used in the light-diffusing resin composition of the present invention are butadiene, methyl methacrylate, styrene and acrylonitrile, whose refractive indices are about 1.518, about 1.49, about 1.59 and about 1.52, respectively.

The refractive index of the monomer mixture or a copolymer thereof, which is graft-polymerized onto the conjugated diene rubber resin as a backbone chain of the transparent thermoplastic resin (A), can be calculated from the following equation:

RI_{copolymer}=Wt_{A}·RI_{A}+Wt_{S}·RI_{S}+Wt_{M}·RI_{M}

### Wt_{A}: % by weight of the vinylcyan compound

### RI_{A}: Refractive index of the vinylcyan polymer

### Wt_{S}: % by weight of the aromatic vinyl compound

### RI_{S}: Refractive index of the aromatic vinyl polymer

### Wt_{M}: % by weight of the alkyl acrylate or alkyl methacrylate

### RI_{S}: Refractive index of the alkyl acrylate or alkyl methacrylate polymer

The transparent thermoplastic resin (A) used in the light-diffusing resin composition of the present invention can be prepared by emulsion polymerization or a combination of emulsion polymerization and bulk polymerization.

According to emulsion polymerization, 20 to 70 parts by weight of the alkyl methacrylate or alkyl acrylate and 8 to 50 parts by weight of the aromatic vinyl compound are graft-polymerized onto 5 to 30 parts by weight of the conjugated diene rubber resin to prepare the transparent thermoplastic resin (A). During the emulsion polymerization, 1 to 20 parts by weight of the vinylcyan compound may be further graft-polymerized onto the conjugated diene rubber resin. The polymer thus prepared is in the form of a latex and may be collected in the form of a dry powder after undergoing aggregation, dehydration and drying.

According to a combination of emulsion polymerization and bulk polymerization, the transparent thermoplastic resin (A) is prepared in accordance with the following procedure. First, a polymer in the form of a dry powder is prepared by emulsion polymerization. Separately, an alkyl methacrylate, an aromatic vinyl compound and a vinylcyan compound are used to prepare a copolymer having the same refractive index as the polymer in the form of a dry powder. Then, the polymer in the form of a dry powder and the copolymer are kneaded using an extruder to prepare the transparent thermoplastic resin (A).

In comparison with emulsion polymerization, the combination of emulsion polymerization and bulk polymerization has the disadvantages that the process is complicated and initial installation of equipment is required, but has advantages in that the content of the conjugated diene rubber resin in the transparent thermoplastic resin (A) is easy to control and the preparation cost is reduced.

The aromatic vinyl compound of the transparent thermoplastic resin (A) used in the light-diffusing resin composition of the present invention may be selected from styrene, α-methylstyrene, p-methylstyrene, vinyl toluene, and mixtures thereof. Styrene is particularly preferred.

The vinylcyan compound may be acrylonitrile or methacrylonitrile.

The alkyl methacrylate may be selected from methyl methacrylate, ethyl methacrylate, propyl methacrylate, 2-ethylhexyl methacrylate, decyl methacrylate, lauryl methacrylate, and mixtures thereof. Particularly preferred is methyl methacrylate.

(B) Light-Diffusing Agent

The light-diffusing resin composition of the present invention comprises a light-diffusing agent (B) as a domain.

As the light-diffusing agent (B), an organic light-diffusing agent, an inorganic light-diffusing agent or a combination thereof may be used.

The light-diffusing agent (B) used in the light-diffusing resin composition of the present invention may have an average particle diameter of 1 to 100 μm. When the light-diffusing agent (B) has an average particle diameter larger than 100 μm, an undesirable degree of light diffusion is obtained. Preferably, the light-diffusing agent (B) has an average particle diameter of 1 to 10 μm.

Examples of suitable inorganic light-diffusing agents that can be used in the light-diffusing resin composition of the present invention include, but are not specially limited to, calcium carbonate, barium sulfate, titanium dioxide, aluminum hydroxide, silica, glass, talc, mica, white carbon, magnesium oxide, and zinc oxide. These inorganic light-diffusing agents may be used alone or as a mixture of two or more thereof.

The inorganic light-diffusing agent may have an average particle diameter of 0.1 to 20 μm. The inorganic light-diffusing agent resin may be used in an amount of 0.1 to 20 parts by weight, based on 100 parts by weight of the transparent thermoplastic resin (A).

The organic light-diffusing agent used in the light-diffusing resin composition of the present invention may be an acrylic resin, a siloxane resin, a polycarbonate resin, or a styrene resin. The organic light-diffusing agent may have an average particle diameter of 1 to 100 μm. The organic light-diffusing agent may be used in an amount of 0.1 to 20 parts by weight, based on 100 parts by weight of the transparent thermoplastic resin (A).

When the light-diffusing agent is used in an amount of less than 0.1 parts by weight, a degree of light diffusion at a desired level cannot be obtained. Meanwhile, when the light-diffusing agent is used in an amount of more than 20 parts by weight, the amount of the transparent thermoplastic resin (A) is relatively lowered, resulting in a decrease in the impact resistance of a finished product and a marked reduction in the transmittance of the finished product.

The difference in refractive index between the transparent thermoplastic resin (A) and the light-diffusing agent (B) used in the light-diffusing resin composition of the present invention is preferably 0.005 or greater and more preferably 0.01 or greater.

If the difference in refractive index is smaller than 0.005, the light diffusion properties of the light-diffusing resin composition are deteriorated and thus the use of a larger amount of the light-diffusing agent is inevitably required.

In addition to the transparent thermoplastic resin (A) and the light-diffusing agent, the light-diffusing composition of the present invention may further comprise at least one additive selected from heat stabilizers, UV stabilizers and fluorescent whitening agent so long as these additives do not adversely affect the physical properties of the light-diffusing composition. The composition is homogeneously dispersed using a single-screw extruder, a twin-screw extruder or a Banbury mixer, passed through a water bath, and cut to into a light-diffusing resin in the form of a pellet.

Hereinafter, the present invention will be explained in more detail with reference to the following examples. The following examples are provided to assist in a further understanding of the invention and are not intended to limit the present invention.

### EXAMPLES

### Preparative Example 1

To 15 parts by weight of a butadiene polymer latex (content of a solvent-insoluble gel: 70%, average particle diameter: 0.3 μm) were continuously added 100 parts by weight of ion-exchanged water, 1.0 part by weight of sodium oleate as an emulsifier, 59 parts by weight of methyl methacrylate, 23 parts by weight of styrene, 3 parts by weight of acrylonitrile, 0.5 parts by weight of tertiary dodecyl mercaptan, 0.048 parts by weight of sodium pyrophosphate, 0.012 parts by weight of dextrose, 0.001 parts by weight of ferrous sulfide and 0.04 parts by weight of cumene hydroperoxide at 75° C. over 5 hours. The mixture was allowed to react. After completion of the reaction, the reaction mixture was heated to 80° C. and aged for one hour. At this time, the polymerization conversion rate was 99.8% and the content of solids agglomerated was 0.1%.

The polymer was agglomerated with an aqueous solution of calcium chloride and washed to give a transparent thermoplastic resin (A-1) in the form of a powder. The transparent thermoplastic resin was found to have a refractive index of 1.516 and a weight average molecular weight of 130,000.

### Preparative Example 2

A transparent thermoplastic resin was synthesized in the same manner as in Preparative Example 1, except that 15 parts by weight of a butadiene polymer latex (content of a solvent-insoluble gel: 70%, average particle diameter: 0.3 μm), 48.3 parts by weight of methyl methacrylate and 18.7 parts by weight of styrene were used. The transparent thermoplastic resin was found to have a refractive index of 1.516 and a weight average molecular weight of 120,000.

(2) 30 parts by weight of toluene as a solvent was mixed with 0.15 parts by weight of di-tert-dodecyl mercaptan as a molecular weight modifier. The mixture was continuously added to 68 parts by weight of methyl methacrylate, 22 parts by weight of styrene and 10 parts by weight of acrylonitrile in a reaction vessel for an average time of 3 hours while maintaining the reaction temperature at 148° C. A polymerization solution was discharged from the reaction vessel, heated in a preliminary heating vessel and the unreacted monomers were volatilized in a volatilization vessel.

Subsequently, the resulting polymer was processed using an extruder at a temperature of 210° C. to produce a pellet. The copolymer was found to have a weight average molecular weight of 130,000 and a refractive index of 1.516.

(3) 50 parts by weight of the transparent thermoplastic resin prepared in (1) and 50 parts by weight of the copolymer prepared in (2) were mixed together in a mixer. The mixture was processed using a twin-screw extrusion kneader at a cylinder temperature at 220° C. to give a transparent thermoplastic resin (A-2) in the form of a pellet.

### Preparative Example 3

A transparent thermoplastic resin (A-3) was prepared in the same manner as in Preparative Example 2(2), except that 100 parts by weight of methyl methacrylate was used without using styrene and acrylonitrile.

### Examples 1 to 3 and Comparative Examples 1 to 5

In accordance with the compositions indicated in Table 2, the transparent thermoplastic resins prepared in Preparative Examples 1 to 3 were mixed with the light-diffusing agents shown in Table 1. To the mixtures were added 0.1 parts by weight of a lubricant and 0.2 parts by weight of an antioxidant. The resulting mixtures were processed using a twin-screw extrusion kneader at a cylinder temperature of 220° C. to produce pellets.

TABLE 1

| | Average | | |
|---|---|---|---|
| | particle | | |
| | diameter | | Refractive |
| | (μm) | Materials | Index |
| B-1 | 7 | Polystyrene (PS) | 1.59 |
| B-2 | 7 | Polymethylmethacrylate | 1.495 |
| | | (PMMA) | |
| B-3 | 7 | PS-PMMA(20:80) copolymer | 1.512 |
| B-4 | 20 | Polystyrene (PS) | 1.59 |
| B-5 | 150 | Polymethylmethacrylate | 1.495 |
| | | (PMMA) | |

TABLE 2

| | Transparent | | | | | | | | |
|---|---|---|---|---|---|---|---|---|---|
| | thermoplastic | | | | Light-diffusing | | | | |
| | resins | | | | agents | | | | |
| Example No. | A-1 | A-2 | A-3 | A-4* | B-1 | B-2 | B-3 | B-4 | B-5 |
| Example 1 | 100 | | | | 5 | | | | |
| Example 2 | 100 | | | | | 5 | | | |
| Example 3 | | 100 | | | | | | 10 | |
| Comparative | | 100 | | | | | 10 | | |
| Example 1 | | | | | | | | | |
| Comparative | 100 | | | | | | | | 5 |
| Example 2 | | | | | | | | | |
| Comparative | 100 | | | | 30 | | | | |
| Example 3 | | | | | | | | | |
| Comparative | | | 100 | | 5 | | | | |
| Example 4 | | | | | | | | | |
| Comparative | | | | 100 | | 5 | | | |
| Example 5 | | | | | | | | | |

A-4* is a polycarbonate resin (Calibre 300-15, LG-Dow PC, Korea)

The pellets were injection-molded to produce specimens. The physical properties of the specimens were evaluated by the following methods.

### 1. Degree of Light Diffusion

The degree of light diffusion was evaluated by measuring the haze value of a 2 mm thick sheet in accordance with the procedure of ASTM D-1003.

### 2. Transmittance (%)

The transmittance was evaluated by measuring the total transmittance of a 2 mm thick sheet in accordance with the procedure of ASTM D-1003.

### 3. Notched Izod Impact Strength (kg·cm/cm)

The impact strength was evaluated by measuring the notched izod impact strength of a ⅛″ thick specimen in accordance with the procedure of ASTM D-256.

### 4. Melt Index

A pellet was produced by extrusion at 220° C. under a load of 10 kg. The flowability was evaluated by measuring the melt index of the pellet in accordance with the procedure of ASTM D-1238.

The obtained results are shown in Table 3.

TABLE 3

| | Degree of | | | |
|---|---|---|---|---|
| | light | | Impact | |
| | diffusion | Total | strength | |
| | (Haze | transmittance | (Imp., | Flowability |
| Example No. | value) | (Tt, %) | kg · cm/cm) | (MI) |
| Example 1 | 89 | 71 | 11 | 15 |
| Example 2 | 82 | 81 | 11 | 12 |
| Example 3 | 83 | 86 | 9 | 11 |
| Comparative | 30 | 87 | 10 | 10 |
| Example 1 | | | | |
| Comparative | 42 | 86 | 12 | 10 |
| Example 2 | | | | |
| Comparative | 92 | 35 | 5 | 7 |
| Example 3 | | | | |
| Comparative | 90 | 69 | <1 | 5 |
| Example 4 | | | | |
| Comparative | 86 | 71 | 30 | — |
| Example 5 | | | | |

Each of the specimens produced in Examples 1 to 3 showed a high haze value, a high total transmittance (Tt), a high impact strength and improved processibility.

In contrast, the difference in refractive index between the transparent thermoplastic resin (A-2) and the light-diffusing agent (B-3) used in Comparative Example 1 was very low (0.004). As a result, desired light diffusion properties were not obtained.

The light-diffusing agent (B-5) used in Comparative Example 2 had a very large average particle diameter. As a result, desired light diffusion properties were not obtained.

The light-diffusing agent (B-1) was used in an excessively large amount in Comparative Example 3, which resulted in a low impact strength and a very low total transmittance.

Polymethylmethacrylate was used as a transparent thermoplastic resin in Comparative Example 4. As a result, an impact strength at a desired level was not obtained.

The polycarbonate resin used in Comparative Example 5 showed poor processibility. As a result, it was found that an increase (≧40° C.) in temperature was necessary during extrusion and injection molding and it was very difficult to process.

As apparent from the above description, the light-diffusing resin composition of the present invention comprises a matrix resin containing a conjugated diene rubber resin. Due to the use of the conjugated diene rubber resin, the light-diffusing resin composition is prepared in a simple manner and exhibits high impact resistance and improved processibility.

What is claimed is:

1. A light-diffusing resin composition, comprising:
100 parts by weight of a transparent thermoplastic resin (A) containing a conjugated diene rubber resin; and
0.1 to 20 parts by weight of a light-diffusing agent (B).

2. The light-diffusing resin composition according to claim 1, wherein the transparent thermoplastic resin (A) is prepared by graft polymerization of a monomer mixture of 20 to 70 parts by weight of an alkyl methacrylate or an alkyl acrylate and 8 to 50 parts by weight of an aromatic vinyl compound onto 5 to 30 parts by weight of a conjugated diene rubber resin.

3. The light-diffusing resin composition according to claim 2, wherein the monomer mixture further comprising 1 to 20 parts by weight of a vinylcyan compound.

4. The light-diffusing resin composition according to claim 1, wherein the transparent thermoplastic resin (A) is prepared by graft polymerization of a copolymer of an alkyl methacrylate or an alkyl acrylate and an aromatic vinyl compound onto a conjugated diene rubber resin.

5. The light-diffusing resin composition according to claim 1, wherein the transparent thermoplastic resin (A) is prepared by graft polymerization of a copolymer of an alkyl methacrylate or an alkyl acrylate, an aromatic vinyl compound and a vinylcyan compound onto a conjugated diene rubber resin.

6. The light-diffusing resin composition according to claim 4, wherein the difference in refractive index between the conjugated diene rubber resin and the copolymer is 0.005 or less.

7. The light-diffusing resin composition according to claim 5, wherein the difference in refractive index between the conjugated diene rubber resin and the copolymer is 0.005 or less.

8. The light-diffusing resin composition according to claim 1, wherein the conjugated diene rubber resin has an average particle diameter of 600 Å to 5,000 Å.

9. The light-diffusing resin composition according to claim 1, wherein the light-diffusing agent (B) has a spherical shape with an average particle diameter of 0.1 to 100 μm.

10. The light-diffusing resin composition according to claim 1, wherein the light-diffusing agent (B) is selected from the group consisting of acrylic resins, siloxane resins, polycarbonate resins, styrene resins, calcium carbonate, barium sulfate, titanium dioxide, aluminum hydroxide, silica, glass, talc, mica, white carbon, magnesium oxide, zinc oxide, and mixtures thereof.

11. The light-diffusing resin composition according to claim 1, wherein the difference in refractive index between the transparent thermoplastic resin (A) and the light-diffusing agent (B) is 0.005 or greater.

12. The light-diffusing resin composition according to claim 4, wherein the transparent thermoplastic resin (A) is prepared by copolymerizing 20 to 70 parts by weight of an alkyl methacrylate or an alkyl acrylate with 8 to 50 parts by weight of an aromatic vinyl compound (a first step) and graft-polymerizing the copolymer with 5 to 30 parts by weight of a conjugated diene rubber (a second step).

13. The light-diffusing resin composition according to claim 12, wherein, in the first step, 1 to 20 parts by weight of a vinylcyan compound is further added during the copolymerization.
